(19) United States
(12) Patent Application Publication
(10) Pub. No.: US 2026/0169792 A1
(43) Pub. Date: Jun. 18, 2026

(54) Power and Performance Aware Scheduler for Multithreaded Systems

(71) Applicant: Mellanox Technologies, Ltd., Yokneam (IL)

(72) Inventors: Doron Haim, Herzliya (IL); Evgeny Pimenov, Pardes Hanna Karkur (IL); Gabi Liron, Yokneam Illit (IL); Gal Barzilai, Kiriat Motzkin (IL); Hagai David, Moshav Gea (IL); Parav Pandit, Bangalore (IN); Sagi Farjun, Modiin (IL); Salvatore Di Girolamo, Zurich (CH); Sayantan Sur, Cary, NC (US); Tzur Raanan, Yokneam Ilit (IL); Uria Basher, Nehusha (IL)

(21) Appl. No.: 18/981,737

(22) Filed: Dec. 16, 2024

(51) Int. Cl. G06F 9/48; G06F 9/50

(52) U.S. Cl. CPC G06F 9/4881; G06F 9/5027; G06F 9/5094; G06F 2209/501

(57) ABSTRACT

An apparatus includes multiple processor cores and a scheduler. The scheduler is to receive one or more program threads, and to select, based at least on a defined power/performance tradeoff measure, at least one processor core from among the multiple processor cores to execute the one or more program threads.

### TECHNICAL FIELD

The present description relates generally to computer systems, and specifically to scheduling of processes in multithreaded multi-processor computer systems.

### BACKGROUND

Computer systems sometimes comprise multiple processor cores and a scheduler that is configured to allocate tasks (e.g., computer programs) for execution by the processor cores. Various scheduling schemes and policies are known in the art.

### SUMMARY

An embodiment that is described herein provides an apparatus including multiple processor cores and a scheduler. The scheduler is to receive one or more program threads, and to select, based at least on a defined power/performance tradeoff measure, at least one processor core from among the multiple processor cores to execute the one or more program threads.

In some embodiments, the scheduler is to select the at least one processor core based on (i) the power/performance tradeoff measure and (ii) a concurrency measure indicative of efficiency of running the one or more program threads concurrently with other threads. In an embodiment, the scheduler is to select the at least one processor core responsively to loads of the multiple Processor Cores in processing existing program threads. In a disclosed embodiment, the scheduler is to send one or more interrupts to the at least one selected processor core, the one or more interrupts instructing the at least one selected processor core to execute the one or more program threads.

In an example embodiment, when the power/performance tradeoff measure has a first value, the scheduler is to select the at least one processor core in accordance with a first scheduling criterion that aims to minimize power consumption of the multiple processor cores; and when the power/performance tradeoff measure has a second value, the scheduler is to select the at least one processor core in accordance with a second scheduling criterion that aims to maximize execution performance of the multiple processor cores.

In another embodiment, when the power/performance tradeoff measure falls in a first range, the scheduler is to select the at least one processor core in accordance with a first scheduling criterion that aims to minimize power consumption of the multiple processor cores; and when the power/performance tradeoff measure falls in a second range, the scheduler is to select the at least one processor core in accordance with a second scheduling criterion that aims to maximize execution performance of the multiple processor cores.

In yet another embodiment, the scheduler is to select the at least one processor core in accordance with a scheduling criterion jointly that considers power consumption and execution performance of the multiple processor cores. In still another embodiment, in response to a change in the power/performance tradeoff measure, the scheduler is to switch between (i) a first scheduling criterion that aims to minimize power consumption of the multiple processor cores and (ii) a second scheduling criterion that aims to maximize execution performance of the multiple processor cores.

There is additionally provided, in accordance with an embodiment that is described herein, a method including receiving one or more program threads. At least one processor core is selected from among multiple processor cores, based at least on a defined power/performance tradeoff measure, to execute the one or more program threads.

The present description will be more fully understood from the following detailed description of the embodiments thereof, taken together with the drawings in which:

### BRIEF DESCRIPTION OF THE DRAWINGS

FIG. 1 is a block diagram that schematically illustrates a multi-processor multi-thread Computer System, in accordance with an embodiment that is described herein;

FIG. 2 is a flowchart that schematically illustrates a method for selecting a thread responsively to a power/performance tradeoff measure (PPTM), in accordance with an embodiment that is described herein.

FIG. 3 is a diagram block that schematically illustrates a Multi-Processor Multi-Thread Computer System that is configured for power optimization, in accordance with an embodiment that is disclosed herein;

FIG. 4 is a block diagram that schematically illustrates a Multi-Processor Multi-Thread Computer System that is configured for performance optimization, in accordance with another embodiment that is disclosed herein; and

FIG. 5 is a block diagram that schematically illustrates a Computing System, e.g., a data center or a High-Performance Computing (HPC) cluster, in accordance with an embodiment that is described herein.

### DETAILED DESCRIPTION OF EMBODIMENTS

### Overview

In a multi-processor computer system, a plurality of Processor Cores may run computing tasks concurrently, wherein some of the Processor Cores run multiple concurrent program-threads (program-threads will be referred to hereinbelow, for short, as threads).

Dispatching new threads for execution is typically done by a Scheduler, which receives (e.g., from an operating system) threads to be executed, and sends the threads to a selected Processor Core, for execution (alternatively, the Scheduler may receive processes, and send corresponding threads to the selected Processor Core).

At any given time, the processing load of the Processor Cores may not be equal; for example, while some Processor Cores may be executing one or more threads, other Processor Cores may be idle.

Embodiments that are disclosed herein provide methods and systems in which the Scheduler submits threads to Idle Processor Cores (for best performance) or to Busy Processor Cores that already execute threads (for lower power consumption). In an embodiment, the Scheduler submits the thread to an Idle or to a Busy Processor Core according to a performance/power-consumption tradeoff measure (PPTM) that the Scheduler receives, e.g., from an operating system.

### System Description

In an embodiment to be disclosed below, a Computer System comprises a plurality of Processor Cores, and a Scheduler that submits threads for execution by a selected one of the Processor Cores.

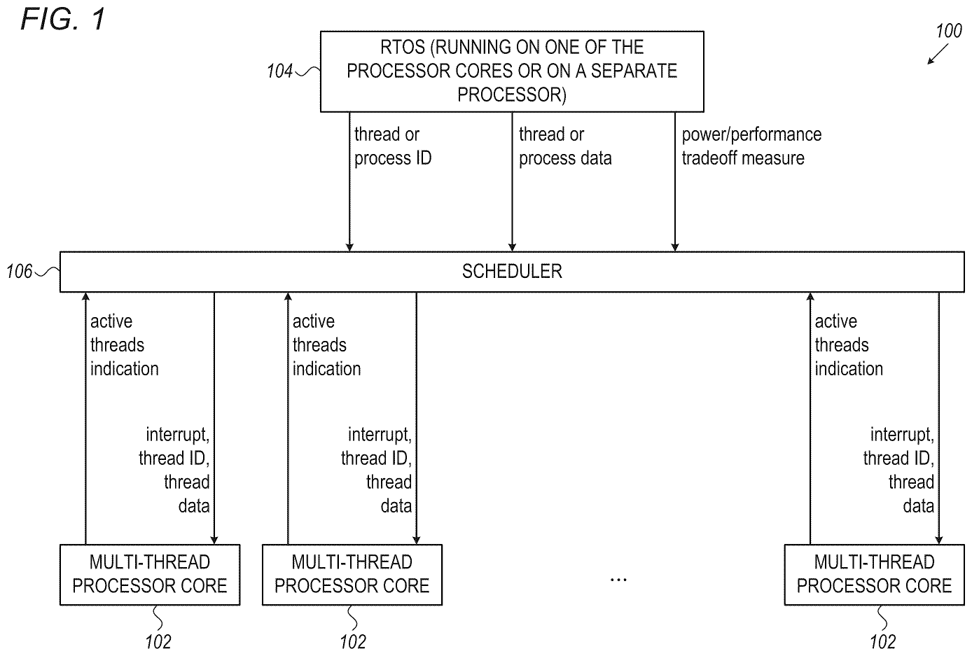

FIG. 1 is a block diagram that schematically illustrates a multi-processor multi-thread Computer System 100, in accordance with an embodiment that is described herein. The Computer System comprises a plurality of Processor Cores 102. Each Processor Core is configured to run a plurality of concurrent threads; for example, in some embodiments, the plurality of threads are time-multiplexed, wherein each thread runs until it needs a missing resource, or until a preset time has elapsed.

In some embodiments, some (or all) of the Processor Cores 102 comprise a tightly coupled memory, a memory management/protection unit (MMU/MPU), a data and/or instruction cache, and others. The Processor Cores may be (but are not necessarily) identical.

Computer system 100 further comprises a Real-Time Operating System 104 that governs the operation of the Computer System. In some embodiments, RTOS 104 may run on one of the Processor Cores; in other embodiments, Computer System 100 comprises a dedicated processor that runs the RTOS (and, in some embodiments, also runs other tasks).

The RTOS may dispatch processes or individual threads for execution. The Computer System comprises a Scheduler 106, and the RTOS sends a process or a thread ID to the Scheduler, along with the thread or process data (the data may be, for example, an application with which the process or thread is associated). In addition, the RTOS sends a Power/Performance tradeoff measure (PPTM) to the Scheduler. The RTOS may occasionally change the PPTM, for example, in response to a heating indication, or to support increasing priority processes. In an embodiment, the PPTM may change on a per-thread resolution.

In some embodiments, the PPTM may be binary, having a first value for performance optimization and a second value for minimum power consumption optimization. In other embodiments, the PPTM may comprise multiple values, e.g., from 1 to 4. (The PPTM values will be interpreted below as a performance over power consumption priority scale, e.g., zero is interpreted as power supply optimization only.) In embodiments, a thread that is submitted for execution to an Idle Processor Core will execute faster than a thread that is submitted to a Processor Core that already executes one or more threads, as the new thread will not have to share running time with other threads. Moreover, a thread that is submitted to a Processor Core that runs a given number of threads will typically run faster than a thread that is submitted to a Processor Core running a larger number of threads. In terms of power consumption, however, submitting a thread to an idle Processor Core will increase the power consumption, whereas submitting the thread to a non-idle Processor Core will not change the power consumption (or change the power consumption by a small amount).

Scheduler 106 receives the process/thread ID, process/thread data and the PPTM from the RTOS and receives Active Thread Indication from the Processor Cores. In an embodiment, the Active Thread Indication may include the number of active threads (where zero implies that the Processor Core is idle); in another embodiment, the Active Thread Indication may be binary, indicating zero active threads (e.g., Processor Core idle) or non-zero, indicating that the Processor Core is Busy. (The term Active Thread Indication will also be referred to as a Load of the Processor Cores hereinbelow.)

According to the example embodiment illustrated in FIG. 1, the Scheduler selects a Processor Core according to a scheduling criterion, which the Scheduler may change when PPTM changes (e.g., changed by the RTOS). In an embodiment, when the PPTM has a first value, or falls in a first range of values, the Scheduler selects a Processor Core in accordance with a first scheduling criterion that aims to minimize power consumption of the multiple processor cores; and, when the PPTM has a second value, or falls in a second range of values, the Scheduler selects the Processor Core in accordance with a second scheduling criterion that aims to maximize execution performance of the Processor Cores. In another embodiment, the criterion jointly considers power consumption and execution performance of the multiple Processor Cores.

In embodiments, the Scheduler may select an Idle Processor Core if the PPTM is high, and a Busy Processor Core if the PPTM is low.

In an example embodiment, the Scheduler uses the following Processor Core selection algorithm:
1. If the PPTM is at the highest possible value-select an idle Processor Core; or select the Processor Core having the smallest number of active threads when there is no idle Processor Core.
2. If the PPTM is at the lowest possible value-select the Processor Core having the smallest number of active threads.
3. If the PPTM is at an intermediate value (e.g., higher than the minimum and lower than the maximum possible values), randomly select a processor, wherein the odds to select an Idle processor are according to the PPTM (e.g., for a PPTM of 4 out of five possible values, the Scheduler may randomly select a number from zero to 1, and then select an idle Processor Core if the number is less than 0.8).

Other Processor Core selection algorithms may be used in alternative embodiments.

In some embodiments, the Scheduler selects a processing core responsively to a criterion that combines the PPTM and other measures. For example, in an embodiment, the criterion includes a Concurrency Measure, which defines the efficiency of running the thread concurrently with other threads (for example a thread comprising frequent external memory accesses, e.g., in which the thread can transfer control to other threads, has a high concurrency measure).

After the Scheduler selects a Processor Core, the Scheduler sends an interrupt indication to the selected Processor Core, along with the thread ID, and the Processor Core, in response to the Interrupt, will run the thread (in some embodiments, the Scheduler sends the thread ID to all Processor Cores in parallel; the Processor Cores that do not receive an Interrupt will ignore the thread ID).

Thus, according to the example embodiment illustrated in FIG. 1 and described herein above, the Scheduler can select a Processor Core according to a target tradeoff measure between an increased performance and a decreased power consumption.

The configuration of Computer System 100 illustrated in FIG. 1 and described herein above is cited by way of example. Other configurations may be used in alternative embodiments. For example, in some embodiments, the Scheduler will select the Processor Core according to some additional criteria, such as affinity to resources that are needed for the application associated with the process. In an embodiment, the Scheduler keeps a processing-core utilization history record, and, if the PPTM-based algorithm finds more than one suitable Processor Core, the Scheduler will prioritize the most seldom-used Processor Core. In another embodiment, if the PPTM-based algorithm finds more than one suitable Processor Core, the Scheduler will select a Processor Core according to a rotating priority scheme.

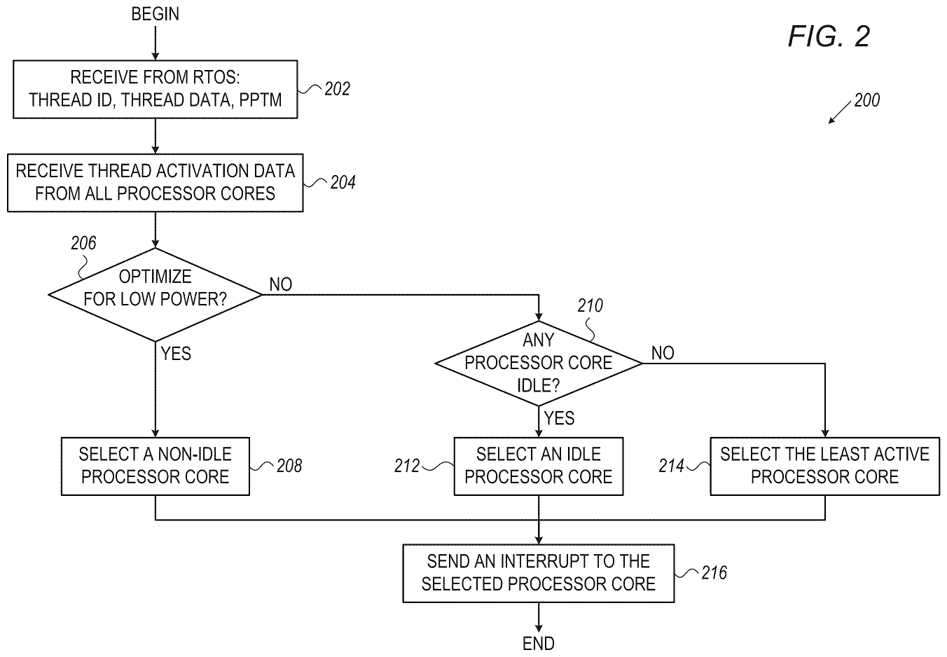

FIG. 2 is a flowchart 200 that schematically illustrates a method for selecting a thread responsively to a power/performance tradeoff measure (PPTM), in accordance with an embodiment that is described herein. The flowchart is executed by Scheduler 106 (FIG. 1).

The flowchart starts at a Receive-Inputs-From-RTOS operation 202, wherein the Scheduler received from the RTOS a thread ID, a corresponding Thread-Data (e.g., an ID of the application associated with the thread), and a Power-Performance-Tradeoff-Measure (PPTM), which indicates a level in which the Scheduler prioritize performance over low power consumption when allocating the thread to a Processor Core (according example embodiment illustrated in FIG. 2, the PPTM is binary, indicating either performance or power consumption optimization).

Next, the Scheduler enters a Receive Thread Activation Data operation 204, wherein the Scheduler receives Thread Activation Indications from the Processor Cores; in some embodiments, the Thread Activation Indication may be binary, indicating either Processing-Core Idle or Processing-Core not-Idle; in other embodiments, the Thread Activation Indication may comprises a number of active threads run by the Processor Core, where zero indicates that the Processor Core is Idle.

Next, in a Check-Performance-Optimization operation 206, the Scheduler checks If the PPTM indicates that the Scheduler should optimize for performance when selecting a Processor Core. If so, the Scheduler will, at a Select-Non-Idle operation 208, select a non-idle Processor Core to execute the thread. If, in operation 206, the PPTM does not indicate performance optimization (and, as the PPTM, according to the current example embodiment, is binary, indicates power optimization), the Scheduler enters a Find Idle Processor Core operation 210, and checks the Thread Activation Indications of the Processor Cores to find if any of the Processor Core is idle. If so, the Scheduler, at a Select-Idle-Processing-Core operation 212, select a Idle Processor Core for the execution of the thread. If, in operation 210, there is no idle Processor Core, the Scheduler will, at a Select-The-Least-Active-Processing-Core operation 214, select the Processor Core with the lowest number of active threads, according to the Thread Activation Indications that the Scheduler received from the Processor Cores (in operation 204).

After each of operations 208, 212 and 214, the Scheduler enters a Send-Interrupt operation 216, wherein the Scheduler sends an Interrupt indication to the selected Processor Core, to start thread execution. After operation 216 the flowchart ends.

The configuration of flowchart 200 illustrated in FIG. 2 and described herein above is cited by way of example. Other configurations may be used in alternative embodiments. For example, in an embodiment, the PPTM is non-binary, and the Scheduler may randomly select Processor Cores, with a an idle-processing-core selection frequency that is determined responsively to the PPTM value. In other embodiments, the Scheduler will select a Processor Core in response to additional information that is not shown, e.g., according to the application associated with the thread.

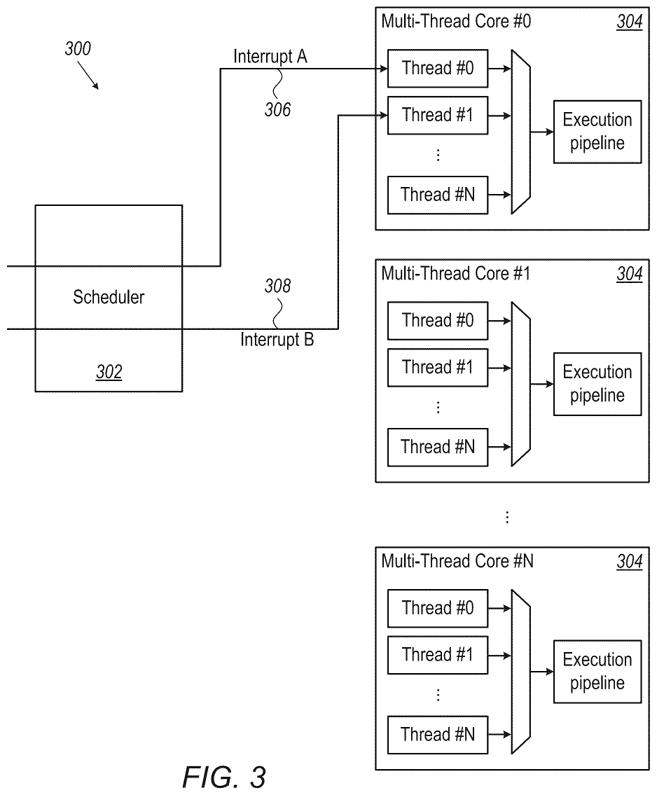

FIG. 3 is a block diagram that schematically illustrates a Multi-Processor Multi-Thread Computer System 300 that is configured for power optimization, in accordance with an embodiment that is disclosed herein. The Multi-Processor Multi-Thread Computer System 300 comprises a Scheduler 302 that is configured to prioritize power optimization, and a plurality of multi-thread cores 304. The Scheduler assigns the two incoming interrupts (an Interrupt A 306 and an Interrupt B 308) to Thread #0 and Thread #1 of Core #0. All other cores (Core #1 through Core #N) remain in a low-power idle state. The execution pipeline of Core #0 is time-shared between the two active threads.

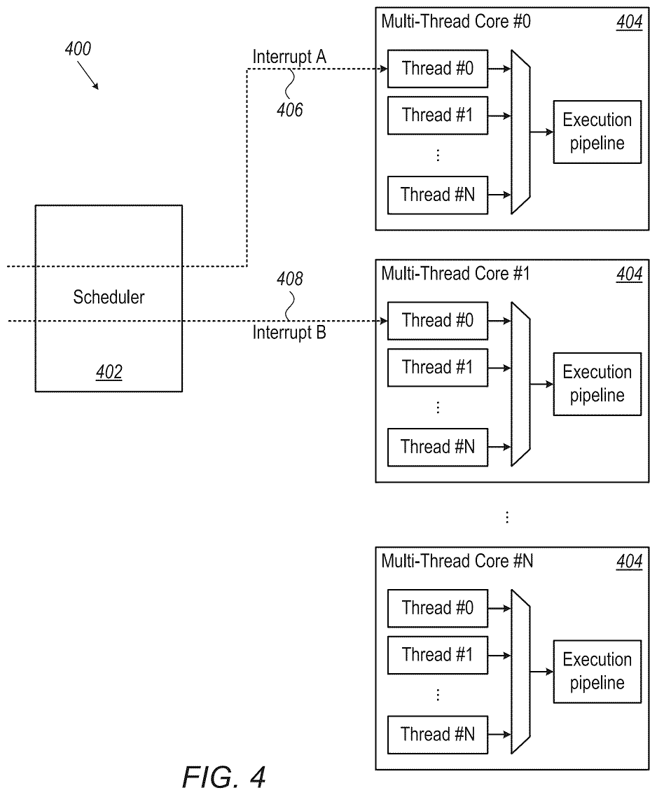

FIG. 4 is a block diagram that schematically illustrates a Multi-Processor Multi-Thread Computer System 400 that is configured for performance optimization, in accordance with an embodiment that is disclosed herein. The Multi-Processor Multi-Thread Computer System 400 comprises a Scheduler 402 that is configured to prioritize performance. The scheduler assigns an Interrupt A 406 to Thread #0 of Core #0, and an Interrupt B 408 to Thread #0 of Core #1. Each active thread can fully utilize its core's execution pipeline, resulting in improved performance (when compared to the performance of Multi-Processor Multi-Thread Computer System 300), at the cost of higher power consumption.

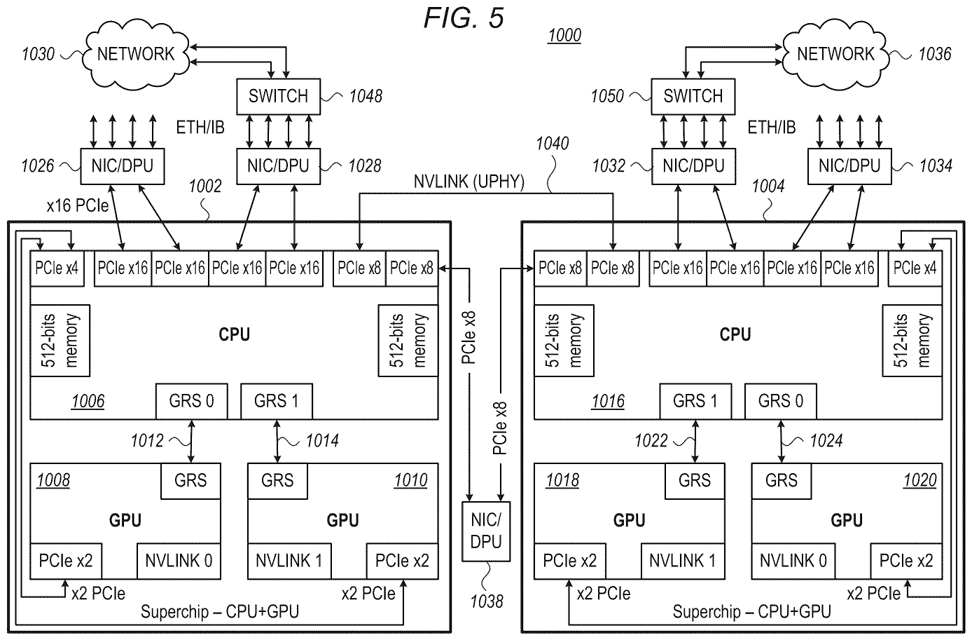

FIG. 5 is a block diagram that schematically illustrates a Computing System 1000, e.g., a data center a High-Performance Computing (HPC) cluster, in accordance with an embodiment that is described herein. System 1000 comprises a plurality of subsystems, e.g. multiple processing devices coupled to each other, multiple network devices, and multiple networks, according to at least one embodiment. Computing system 1000 is designed with multiple integrated circuits (referred to as processing devices), where each integrated circuit can include one or more CPUs and GPUs, forming a powerful and flexible architecture.

The various processing devices are interconnected via an NVLink or other high-speed interconnect, enabling high-speed communication between the subsystems, and are also connected through a NIC or DPU to ensure efficient data transfer across computing system 1000 and to one or more external networks 1030, 1036. In the present example, system 1000 comprises a packet switch 1048 that connects NIC/DPU 1028 to network 1030, and a packet switch 1050 that connects NIC/DPU 1032 to network 1036.

The coupling of processing devices through NVLink allows for seamless data exchange and parallel processing, enhancing overall computational performance. The processing devices are connected to multiple networks through one or more network interface cards (NICs) or DPUS, enabling the system to handle complex, multi-network tasks with high bandwidth and low latency. This configuration is highly suitable for demanding applications that require significant processing power, such as artificial intelligence (AI), machine learning (ML), and data-intensive computing, while ensuring robust connectivity and scalability across various networked environments. The integrated circuits of the computing system 1000 can include one or more CPUs and one or more GPUs.

FIG. 5 also demonstrates an example architecture of a multi-GPU architecture. As illustrated in the figure, computing system 1000 includes a processing device 1002 with a multi-GPU architecture. In particular, processing device 1002 may be a system-on-chip and includes multiple subsystems such as a CPU 1006, a GPU 1008, and a GPU 1010. CPU 1006 can be coupled to GPU 1008 via a die-to-die (D2D) or chip-to-chip (C2C) interconnect 1012, such as a Ground-Referenced Signaling interconnect (GRS interconnect). CPU 1006 can be coupled to GPU 1010 via a D2D or C2C interconnect 1014. CPU 1006 can also couple to GPU 1008 and GPU 1010 via PCIe interconnects.

CPU 1006 can be coupled to one or more NICs or DPUs, which are coupled to one or more networks. For example, as illustrated in FIG. 5, CPU 1006 is coupled to a first NIC/DPU 1026, which is coupled to a network 1030. CPU 1006 is also coupled to a second NIC/DPU 1028, which is coupled to network 1030 via switch 1048. NIC/DPU 1026 and NIC/DPU 1028 can be coupled to network 1030 over Ethernet (ETH), NVLINK or InfiniBand (IB) connections, for example.

Computing system 1000 also includes a processing device 1004 with a multi-GPU architecture. In particular, processing device 1004 includes multiple subsystems including a CPU 1016, a GPU 1018, and a GPU 1020. CPU 1016 can be coupled to GPU 1018 via an D2D or C2C interconnect 1022. CPU 1016 can be coupled to GPU 1020 via a D2D or C2C interconnect 1024. CPU 1016 can also couple to GPU 1018 and GPU 1020 via PCIe interconnects. CPU 1016 can be coupled to one or more NICs or DPUs, which are coupled to one or more networks. For example, as illustrated in FIG. 5, CPU 1016 is coupled to a first NIC/DPU 1032, which is coupled to a network 1036. CPU 1016 is also coupled to a second NIC/DPU 1034, which is coupled to network 1036 via switch 1050. NIC/DPU 1032 and NIC/DPU 1034 can be coupled to network 1036 over Ethernet (ETH), NVLINK or InfiniBand (IB) connections.

In at least one embodiment, processing device 1002 and processing device 1004 can communicate with each other via a NIC/DPU 1038, such as over PCIe interconnects. Processing device 1002 and processing device 1004 can also communicate with each other over a high-bandwidth communication interconnects 1040, such as an NVLink interconnect or other high-speed interconnects.

In various embodiments, any of the network devices of system 1000, e.g., any of NICs/DPUs 1026, 1028, 1032, 1034 and 1038 and/or switches 1048 and 1050, and/or any of CPUs 1006, 1016, GPUs 1008, 1010, 108 and 1020, may comprise a scheduler and a plurality of multi-thread processors, wherein the scheduler is configured to assign tasks to threads of the multi-thread processors while optimizing for power consumption or for performance, in accordance with the techniques described herein.

The apparatuses and methods described hereinabove, with reference to FIGS. 1, 2, 3, 4 and 5 including the configuration of Computer Systems 100, 300, 400 and 1000 and including all units and subunits thereof, are example configurations, and methods that are shown purely for the sake of conceptual clarity. Any other suitable methods and configurations can be used in alternative embodiments. For example, in embodiments, the Scheduler sends complete processes to the selected Processor Core, which breaks the process into threads.

In various embodiments, Computer System 100, including subunits thereof, may be implemented using suitable hardware, such as one or more Application-Specific Integrated Circuits (ASIC) or Field-Programmable Gate Arrays (FPGA), or a combination of ASIC and FPGA.

It will be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to p skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. An apparatus, comprising:
multiple processor cores; and
a scheduler, to:
receive one or more program threads; and
select, based at least on a defined power/performance tradeoff measure, at least one processor core from among the multiple processor cores to execute the one or more program threads.

2. The apparatus according to claim 1, wherein the scheduler is to select the at least one processor core based on (i) the power/performance tradeoff measure and (ii) a concurrency measure indicative of efficiency of running the one or more program threads concurrently with other threads.

3. The apparatus according to claim 1, wherein the scheduler is to select the at least one processor core responsively to loads of the multiple Processor Cores in processing existing program threads.

4. The apparatus according to claim 1, wherein the scheduler is to send one or more interrupts to the at least one selected processor core, the one or more interrupts instructing the at least one selected processor core to execute the one or more program threads.

5. The apparatus according to claim 1, wherein:
when the power/performance tradeoff measure has a first value, the scheduler is to select the at least one processor core in accordance with a first scheduling criterion that aims to minimize power consumption of the multiple processor cores; and
when the power/performance tradeoff measure has a second value, the scheduler is to select the at least one processor core in accordance with a second scheduling criterion that aims to maximize execution performance of the multiple processor cores.

6. The apparatus according to claim 1, wherein:
when the power/performance tradeoff measure falls in a first range, the scheduler is to select the at least one processor core in accordance with a first scheduling criterion that aims to minimize power consumption of the multiple processor cores; and
when the power/performance tradeoff measure falls in a second range, the scheduler is to select the at least one processor core in accordance with a second scheduling criterion that aims to maximize execution performance of the multiple processor cores.

7. The apparatus according to claim 1, wherein the scheduler is to select the at least one processor core in accordance with a scheduling criterion that jointly considers power consumption and execution performance of the multiple processor cores.

8. The apparatus according to claim 1, wherein, in response to a change in the power/performance tradeoff measure, the scheduler is to switch between (i) a first scheduling criterion that aims to minimize power consumption of the multiple processor cores and (ii) a second scheduling criterion that aims to maximize execution performance of the multiple processor cores.

9. A method, comprising:
receiving one or more program threads; and
selecting, based at least on a defined power/performance tradeoff measure, at least one processor core from among multiple processor cores to execute the one or more program threads.

10. The method according to claim 9, wherein selecting the at least one processor core is performed based on (i) the power/performance tradeoff measure and (ii) a concurrency measure indicative of efficiency of running the one or more program threads concurrently with other threads.

11. The method according to claim 9, wherein selecting the at least one processor core is performed responsively to loads of the multiple Processor Cores in processing existing program threads.

12. The method according to claim 9, further comprising sending one or more interrupts to the at least one selected processor core, the one or more interrupts instructing the at least one selected processor core to execute the one or more program threads.

13. The method according to claim 9, wherein selecting the at least one processor comprises:
when the power/performance tradeoff measure has a first value, selecting the at least one processor core in accordance with a first scheduling criterion that aims to minimize power consumption of the multiple processor cores; and
when the power/performance tradeoff measure has a second value, selecting the at least one processor core in accordance with a second scheduling criterion that aims to maximize execution performance of the multiple processor cores.

14. The method according to claim 9, wherein selecting the at least one processor comprises:
when the power/performance tradeoff measure falls in a first range, selecting the at least one processor core in accordance with a first scheduling criterion that aims to minimize power consumption of the multiple processor cores; and
when the power/performance tradeoff measure falls in a second range, selecting the at least one processor core in accordance with a second scheduling criterion that aims to maximize execution performance of the multiple processor cores.

15. The method according to claim 9, wherein selecting the at least one processor core is performed in accordance with a scheduling criterion that jointly considers power consumption and execution performance of the multiple processor cores.

16. The method according to claim 9, wherein selecting the at least one processor core comprises, in response to a change in the power/performance tradeoff measure, switching between (i) a first scheduling criterion that aims to minimize power consumption of the multiple processor cores and (ii) a second scheduling criterion that aims to maximize execution performance of the multiple processor cores.
